(19) United States
(12) Patent Application Publication
(10) Pub. No.: US 2014/0036880 A1
(43) Pub. Date: Feb. 6, 2014

(54) METHOD AND APPARATUS TO PROVIDE A-PERIODIC SOUNDING REFERENCE SIGNAL

(71) Applicant: Lars Dalsgaard, Oulu (FI)

(72) Inventor: Lars Dalsgaard, Oulu (FI)

(73) Assignee: NOKIA CORPORATION, Espoo (FI)

(21) Appl. No.: 14/000,154

(22) PCT Filed: Jan. 18, 2012
(86) PCT No.: PCT/FI12/50038

§ 371 Date: Oct. 16, 2013

Related U.S. Application Data
(60) Provisional application No. 61/463,617, filed on Feb. 18, 2011.

(51) Int. Cl. H04L 5/00

(52) U.S. Cl. CPC H04L 5/0051
USPC 370/336; 370/328; 370/329

(57) ABSTRACT

In accordance with the exemplary embodiments, there is at least a method and an apparatus, the apparatus including computer program code executed by at least one processor to cause the apparatus to perform the method including operating an apparatus to detect an occurrence of at least one trigger condition, where the occurrence of the at least one trigger condition is indicative at least of user equipment having data buffered for an uplink transmission, and in response to the detection of the occurrence of the at least one trigger condition, transmitting an a-periodic sounding reference symbol to a network access node.

### TECHNICAL FIELD

The exemplary and non-limiting embodiments of this invention relate generally to wireless communication systems, methods, devices and computer programs and, more specifically, relate to transmission of a reference signal from a mobile device to a network access node.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project

A-SRS a-periodic sounding reference symbol

BSR buffer status report

CSI channel state information

CQI channel quality indicator

DCI downlink control information

DL downlink (eNB towards UE)

DRX discontinuous reception

eNB E-UTRAN Node B (evolved Node B)

EPC evolved packet core

E-UTRAN evolved UTRAN (LTE)

FDMA frequency division multiple access

IMTA international mobile telecommunications association

ITU-R international telecommunication union-radiocommunication sector

LTE long term evolution of UTRAN (E-UTRAN)

LTE-A LTE advanced

MAC medium access control (layer 2, L2)

MM/MME mobility management/mobility management entity

NodeB base station

OFDMA orthogonal frequency division multiple access

O&M operations and maintenance

PDCP packet data convergence protocol

PHY physical (layer 1, L1)

PMI precoding matrix indicator

PUCCH physical uplink control channel

PUSCH physical uplink shared channel

Rel release

RI rank indicator

RLC radio link control

RRC radio resource control

RRM radio resource management

SGW serving gateway

SC-FDMA single carrier, frequency division multiple access

SR scheduling request

SRS sounding reference symbol

TA timing alignment (or timing advance)

UE user equipment, such as a mobile station, mobile node or mobile terminal

UL uplink (UE towards eNB)

UPE user plane entity

UTRAN universal terrestrial radio access network

One modern communication system is known as evolved UTRAN (E-UTRAN, also referred to as UTRAN-LTE or as E-UTRA). In this system the DL access technique is OFDMA, and the UL access technique is SC-FDMA. It is noted that in at least these types of communication systems use reference signals. However, problems and shortfalls are seen to be present at least with regards to a transmission of reference signals from devices, such as user equipment.

### SOME EXAMPLE EMBODIMENTS

Therefore, there is a need for an approach to address at least problems and/or shortfalls related to at least the transmission of reference signals from a device to a network access node in a communication network.

According to one embodiment, a method comprises processing and/or facilitating a processing and/or operation of an apparatus to detect an occurrence of at least one trigger condition, where the occurrence of the at least one trigger condition is indicative at least of user equipment having data buffered for an uplink transmission, and transmit, in response to the detection of the occurrence of the at least one trigger condition, an a-periodic sounding reference symbol to a network access node.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing and/or operations of the apparatus to at least operate the apparatus to detect an occurrence of at least one trigger condition, where the occurrence of the at least one trigger condition is indicative at least of the apparatus having data buffered for an uplink transmission; and in response to the detection of the occurrence of the at least one trigger condition, transmit an a-periodic sounding reference symbol to a network access node.

According to another embodiment, an apparatus comprises means for processing and/or facilitating the method, and the means including means for operating an apparatus to detect an occurrence of at least one trigger condition, where the occurrence of the at least one trigger condition is indicative at least of a user equipment having data buffered for an uplink transmission, and means, in response to the detection of the occurrence of the at least one trigger condition, for transmitting an a-periodic sounding reference symbol to a network access node.

In accordance with the paragraph above, the means for operating, detecting and transmitting comprises an interface to a communication network, at least one processor, and at least one memory storing at least one computer program code, the at least one computer program code executable by the at least one processor.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

FIG. 1A reproduces Figure 4.1 of 3GPP TS 36.300, and shows the overall architecture of the E-UTRAN system;

FIG. 1B is based on Figure 1 of Tdoc R2-110954, and shows the benefits of not masking type-1 triggered SRS with active time;

FIG. 2 shows a simplified block diagram of various electronic devices that are suitable for use in practicing the exemplary embodiments of this invention; and

FIG. 3 is a logic flow diagram that illustrates the operation of a method, and a result of execution of computer program instructions embodied on a computer readable medium, in accordance with the exemplary embodiments of this invention.

### DESCRIPTION OF SOME EMBODIMENTS

Examples of a novel method, apparatus, and computer program for addressing present shortfalls and improving at least operations related to reference signals sent from devices, such as mobile or user devices, to a network access node are disclosed.

In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

A One specification of interest is 3GPP TS 36.300, V8.11.0 (2009-12), 3rd Generation Partnership Project; Technical Specification Group Radio Access Network; Evolved Universal Terrestrial Radio Access (E-UTRA) and Evolved Universal Terrestrial Access Network (EUTRAN); Overall description; Stage 2 (Release 8), incorporated by reference herein in its entirety. This system may be referred to for convenience as LTE Rel-8. In general, the set of specifications given generally as 3GPP TS 36.xyz (e.g., 36.211, 36.311, 36.312, etc.) may be seen as describing the Release 8 LTE system. More recently, Release 9 and Release 10 versions of at least some of these specifications have been published including 3GPP TS 36.300, V10.2.0 (2010-12).

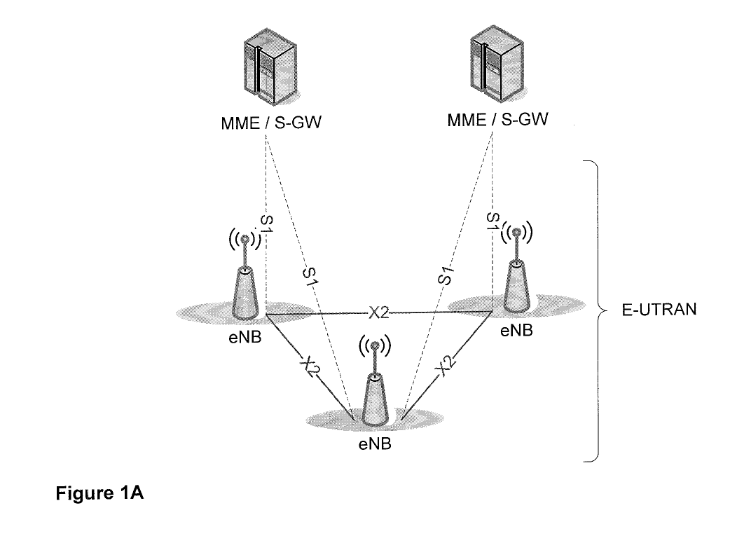

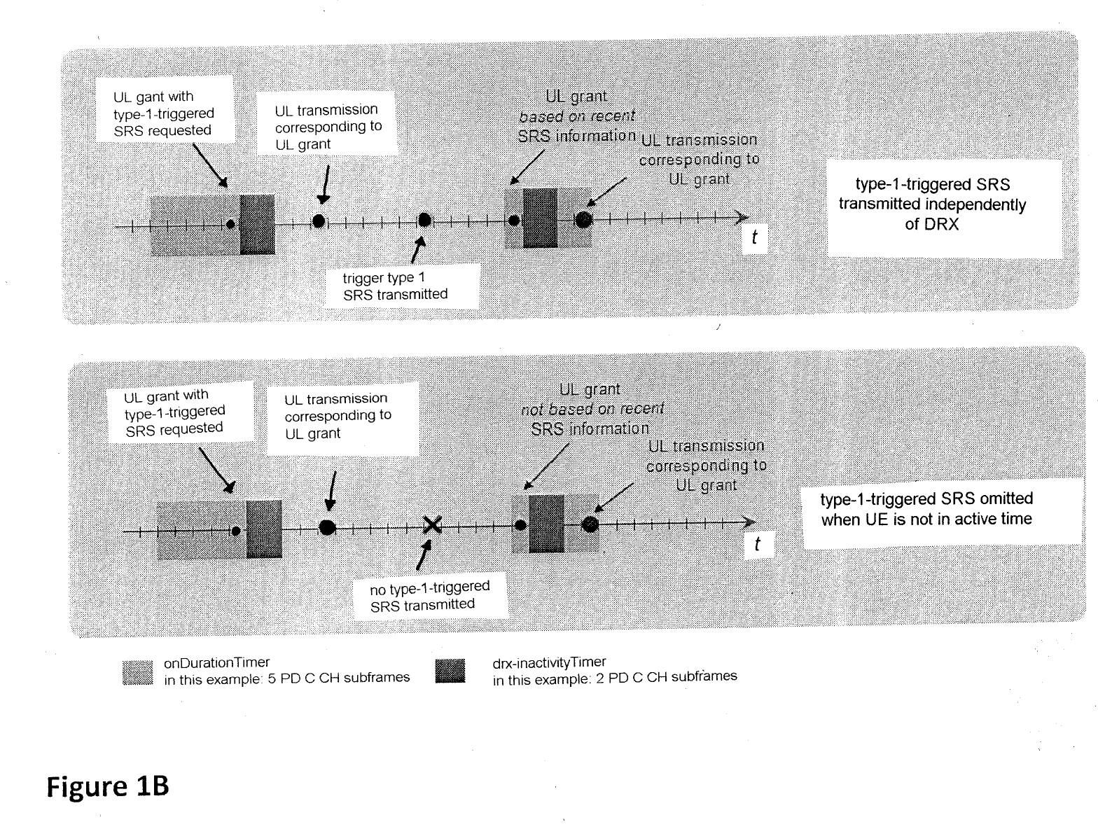

FIG. 1A reproduces Figure 4.1 of 3GPP TS 36.300 and shows the overall architecture of the EUTRAN system (Rel-8). The E-UTRAN system includes eNBs, providing the E-UTRAN user plane (PDCP/RLC/MAC/PHY) and control plane (RRC) protocol terminations towards the UEs. The eNBs are interconnected with each other by means of an X2 interface. The eNBs are also connected by means of an S1 interface to an EPC, more specifically to a MME by means of a S1 MME interface and to a S-GW by means of a S1 interface (MME/S-GW 4). The S1 interface supports a many-to-many relationship between MMEs/S-GWs/UPEs and eNBs.

The eNB hosts the following functions:

functions for RRM: RRC, Radio Admission Control, Connection Mobility Control, Dynamic allocation of resources to UEs in both UL and DL (scheduling);

IP header compression and encryption of the user data stream;

selection of a MME at UE attachment;

routing of User Plane data towards the EPC (MME/S-GW);

scheduling and transmission of paging messages (originated from the MME);

scheduling and transmission of broadcast information (originated from the MME or O&M); and

a measurement and measurement reporting configuration for mobility and scheduling.

Also of interest herein are the further releases of 3GPP LTE (e.g., LTE Rel-10) targeted towards future IMT-A systems, referred to herein for convenience simply as LTE-Advanced (LTE-A). Reference in this regard may be made to 3GPP TR 36.913 V9.0.0 (2009-12) Technical Report 3rd Generation Partnership Project; Technical Specification Group Radio Access Network; Requirements for further advancements for Evolved Universal Terrestrial Radio Access (E-UTRA) (LTE-Advanced) (Release 9). Reference can also be made to 3GPP TR 36.912 V9.3.0 (2010-06) Technical Report 3rd Generation Partnership Project; Technical Specification Group Radio Access Network; Feasibility study for Further Advancements for E-UTRA (LTE-Advanced) (Release 9).

A goal of LTE-A is to provide significantly enhanced services by means of higher data rates and lower latency with reduced cost. LTE-A is directed toward extending and optimizing the 3GPP LTE Rel-8 radio access technologies to provide higher data rates at lower cost. LTE-A will be a more optimized radio system fulfilling the ITU-R requirements for IMT-Advanced while keeping the backward compatibility with LTE Rel-8.

The UE transmission of a SRS for uplink channel estimation is used when no PUCCH or PUSCH are scheduled. Parameters provided by the upper layers include SRS periodicity and duration, symbol location in the subframe, frequency hopping, cyclic shift, and repetition factors.

Of particular interest herein, reference can be made to 3GPP TSG-RAN WG2 #73, Tdoc R2-110954, Taipei, Taiwan, Feb. 21-25, 2011, Agenda Item: 7.1.4.1 Source: Ericsson, ST-Ericsson, Title: SRS and DRX, which is attached hereto as Exhibit A and incorporated by reference. This document states that in RAN2#72bis, SRS reporting and the masking of SRS reporting with the DRX active time was discussed based on the new trigger type for SRS introduced in Rel 10 by RANI. The higher-layer configured, periodic SRS reporting specified for Rel 8/9 is defined as trigger type 0 in Rel 10 and a new UL DCI triggered, aperiodic SRS reporting added in Rel 10 is defined as trigger type 1 in 3GPP TS 36.213 V10.0.1 (2010-12) Technical Specification, 3^{rd} Generation Partnership Project; Technical Specification Group Radio Access Network; Evolved Universal Terrestrial Radio Access (E-UTRA); Physical layer procedures (Release 10), sections 5.1.3 and 8.2 of which are incorporated by reference herein in its entirety:

A UE shall transmit Sounding Reference Symbol (SRS) on per serving cell SRS resources based on two trigger types:
trigger type 0: higher layer signalling
trigger type 1: UL DCI formats.

Tdoc R2-110954 is said to re-examine the question of DRX masking of the added trigger type 1 SRS, and proposes that the interaction between type-1-triggered SRS and DRX should be the same as the interaction between aperiodic CSI and DRX, due to the many similarities between type-l-triggered SRS and aperiodic CSI.

Tdoc R2-110954 continues as follows, the DRX section of the MAC specification (3GPP TS 36.321 Technical Specification 3rd Generation Partnership Project; Technical Specification Group Radio Access Network; Evolved Universal Terrestrial Radio Access (E-UTRA); Medium Access Control (MAC) protocol specification (Release 10) (sections 5.4.4, 5.4.5, 5.7 and 5.10 of which are incorporated by reference herein in its entirety) was originally written to cover only the type-0-triggered SRS, that is, the periodic SRS, as that was the only kind SRS specified in Rel 8/9. It is useful to limit the UE's transmission of the periodic SRS to active time, to avoid unnecessary transmissions causing radio resource usage and wasting UE battery. However, SRS masking with active time has not been considered for the new kind of SRS transmission added in Rel 10, the type-1-triggered SRS. Hence, it should be investigated how to best fit the new kind of SRS into the DRX framework.

Principle:

Section 5.7 of 3GPP TS 36.321 states that SRS shall not be reported when the UE is not in active time, a statement which was intended to refer to the reporting of periodic SRS. Similarly, periodic CSI (CQI/PMI/RI) shall not be reported on PUCCH when the UE is not in active time (if cqi-Mask is not setup), or if the onDurationTimer is not running (if cqi-Mask is setup):

When DRX is configured, the UE shall for each subframe:

[ . . . ]
when not in Active Time, SRS shall not be reported.
if CQI masking (cqi-Mask) is setup by upper layers:
when onDurationTimer is not running, CQI/PMI/RI on PUCCH shall not be reported.
else:
when not in Active Time, CQI/PMI/RI on PUCCH shall not be reported.

Tdoc R2-110954 continues by stating that from the fact that only CSI transmitted on PUCCH is affected by the DRX masking, it is clear that the intention was to avoid unnecessary PUCCH transmissions. The masking was made to prevent transmission of many CSI reports during times when the eNB might not benefit significantly from updated DL channel knowledge, as the UE can anyway not be scheduled when not in active time.

The inventor notes that masking was also introduced to reduce the impact on UE power consumption from transmitting CSI unnecessarily (e.g., the eNB would not in any case be able to schedule the UE while it is in DRX). Further, the PUCCH resources (e.g., for CSI transmission) are scarce resources, and it is desirable to be able to predict exactly when the different resources are reserved for one UE such that available resources can be shared (e.g., in the time domain) between multiple UEs.

Tdoc R2-110954 continues by stating that the aperiodic, UL DCI-triggered CSI is however not affected by any masking with active time or any DRX timers; if aperiodic CSI is requested by the eNB by setting the CSI request bits in the UL DCI, the UE transmits aperiodic CSI as requested. Such CSI transmission of course also consumes both radio resources and UE battery, but is acceptable as it is:
a) one-shot transmission, and
b) only sent when explicitly requested.

As the aperiodic CSI is controlled by the eNB, the eNB provides controlled UE battery consumption and controlled radio resource usage.

The inventor further notes that CSI is used as an input for the eNB DL scheduler. That is, the network would or should use the aperiodic CSI when there is DL data available for transmission (and this is known by the eNB).

Tdoc R2-110954 continues by stating that when the aperiodic and periodic CSI reporting is compared with the type-0-(periodic) and type-1-triggered (aperiodic) SRS, the similarities are striking Type-0-triggered SRS is omitted when the UE is not in active time (similar to CSI on PUCCH), and type-1-triggered SRS is a one-shot transmission (RANI has agreed on one-shot transmissions, and has one more meeting to discuss if a limited train of SRS transmissions will also be supported) only sent when explicitly requested.

Hence, the type-1-triggered SRS is under the eNB full control and hence also the UE battery consumption and the radio resource usage, even if such SRS transmissions are not masked by active time.

In fact, no L1-requested transmissions are affected by DRX. When the eNB grants a PUSCH transmission, with or without requested PUSCH CSI, such transmission takes place regardless of DRX status. Transmission of A/N in response to DL transmissions is also independent of DRX.

In light of this, the following observation is made in Tdoc R2-110954:

Observation: Masking of UL DCI-triggered SRS with active time or any other DRX timer would be an exception to the principle that L1-requested UL transmissions are performed when requested.

Tdoc R2-110954 continues by stating that in an FDD system, CSI provides DL channel information and SRS provides UL channel information. In a TDD system, thanks to channel reciprocity, there is also a degree of UL channel information in the CSI and DL channel information in the SRS. For both CSI and SRS, the channel information is of a short-term nature—how short term of course varies with the UE speed, the antenna setup and the radio environment. It should be noted that SRS can give the eNB a more up-to-date view of the channel compared to CSI, which has a reporting delay, and a more detailed view, as CSI is compressed in one way or the other, depending on the CSI reporting mode. It is hence essential that the SRS information is recent, for scheduling and link adaptation to get the best possible gain from the SRS information.

In the example shown in FIG. 1B (Figure 1 in Tdoc R2-110954), the eNB foresees that a UE will have data to transmit in its next onDuration. The eNB will hence give the UE an UL grant in the beginning of the UE's next onDuration (grant and corresponding transmission shown in darkest shade). For the scheduling of the UE and the link adaptation, it is beneficial for the eNB to have recent UL channel information, from e.g. SRS transmissions. The two possibilities of masking or not masking the UL DCI-triggered SRS with the UE's active time are illustrated in the upper and lower parts of the figure, respectively.

In the upper part of the Figure a type-1-triggered SRS is requested in the previous onDuration (shown in the lighter shade), and occurs shortly before the beginning of the second onDuration, although the UE is not in active time when the SRS is transmitted. Such an SRS transmission gives the eNB updated channel information on which it can base the UL grant sent in the beginning of the second onDuration.

In the lower part of the figure, the type-l-triggered SRS is requested at the same point in time as in the upper part of the figure, but the actual transmission is omitted since the UE is not in active time. Hence, there is no up-to-date SRS-based channel information when time comes for the scheduling and link adaptation of the UL grant in dark blue. Possibly, the eNB may base the scheduling and link adaptation of the second UL grant on older SRS channel information, but in this case, such SRS transmission will be at best from the previous onDuration, and may already be outdated.

Tdoc R2-110954 continues by stating that an alternative solution, to ensure fresh channel information also if type-1-triggered SRS is omitted when the UE is not in active time, would be to configure DRX timers to increase active time. For example, the drx-InactivityTimer could be set so that the resource for the type-1-triggered SRS is always in active time. The time details of the resource for type-1-triggered SRS are still to be fixed by RANI but if requested in subframe n, the SRS is due in subframe n+(4-10). Setting, for example, the drx-InactivityTimer to a sufficiently large value could ensure that the SRS resource is within active time, but such DRX timer settings are most likely worse for UE battery consumption than allowing type-1-triggered SRS transmission in non-active time.

Another, more complex, alternative would be to allow the transmission of type-1-triggered SRS only within a certain time period, say x ms, before the beginning of active time. This would mean that type-1-triggered SRS reports are only sent when the UE will soon be in active time and hence be able to benefit from the eNB having up-to-date channel knowledge. As active time consists of a number of different timers, a simplification to limit UE complexity could be to count the x ms from the beginning of the next onDurationTimer. However, both with and without the simplification, such a solution would be more complex than always allowing transmission of type-1-triggered SRS, regardless of active time, and the gain of allowing the transmission of type-1-triggered SRS only in certain circumstances is questionable compared to the UE always transmitting type-1-triggered SRS, when requested to do so by the eNB.

Also of interest herein is 3GPP TSG-RAN WG2 Meeting #73, R2-111033, Taipei, Feb. 21-25, 2011, Agenda item: 7.1.4, Source: Huawei, HiSilicon, HT mMobile Inc., Title: Aperiodic SRS Transmission in Sleep Time which is incorporated by reference herein in its entirety.

R2-111033 states in part that it has been discussed whether the Aperiodic Sounding Reference Signal (A-SRS) shall be reported when the UE is out of the active time. RAN2 did not agree to always report A-SRS as proposed in R2-110392, but further consideration is allowed. R2-111033 is said to analyze the potential scenarios where A-SRS reporting falls in the sleep time.

It should be noted with regard to the above-described type-1-triggered SRS being under the full control of the eNB that one significant difference as compared to CSI is that the eNB does not always have knowledge about the UL data buffer status in the UE (while for the DL case the eNB will always have the full visibility).

The current specifications only cover periodic SRS. The periodic SRS has been part of the E-UTRAN specification beginning with early Rel-8 specifications. The periodic SRS is specified in, for example, the above-referenced 3GPP TS 36.213 and 3GPP TS 36.321 (transmission limitations).

For example, 3GPP TS 36.213 describes in section 5.1.3.1 the UE behavior in setting the UE transmit power for SRS transmission on a subframe i for a serving cell c. Section 8.2 (pages 69-72) of 3GPP TS 36.213 describes the UE sounding procedure in detail. In addition, 3GPP TS 36.321 in section 5.7 describes DRX operation and also SRS transmissions.

In some cases the a-periodic SRS could be useful, but the currently proposed functionality is not optimized for practical usage in, as one non-limiting example, always online smart phones.

The exemplary embodiments of this invention provide enhancements and improvements to the currently discussed a-periodic SRS transmission such that the behavior is optimized at least in terms of UE power consumption and UL transmissions.

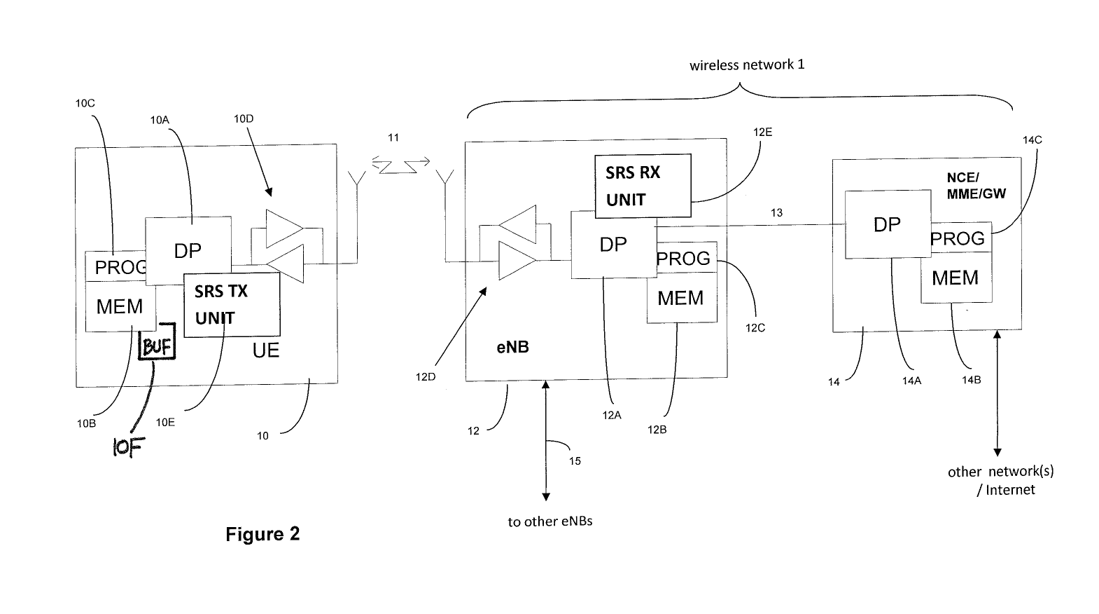

Before describing in further detail the exemplary embodiments of this invention, reference is made to FIG. 2 for illustrating a simplified block diagram of various electronic devices and apparatus that are suitable for use in practicing the exemplary embodiments of this invention. In FIG. 2 a wireless network 1 is adapted for communication over a wireless link 11 with an apparatus, such as a mobile communication device which may be referred to as a UE 10, via a network access node, such as a Node B (base station), and more specifically an eNB 12. The network 1 may include a network control element (NCE) 14 that may include the MME/SGW functionality shown in FIG. 1A, and which provides connectivity with a further network, such as a telephone network and/or a data communications network (e.g., the internet). The UE 10 can be battery powered, and includes a controller, such as at least one computer or a data processor (DP) 10A, at least one non-transitory computer-readable memory medium embodied as a memory (MEM) 10B that stores a program of computer instructions (PROG) 10C, and at least one suitable radio frequency (RF) transmitter/receiver pair (transceiver) 10D for bidirectional wireless communications with the eNB 12 via one or more antennas. The eNB 12 also includes a controller, such as at least one computer or a data processor (DP) 12A, at least one computer-readable memory medium embodied as a memory (MEM) 12B that stores a program of computer instructions (PROG) 12C, and at least one suitable RF transceiver 12D for communication with the UE 10 via one or more antennas (typically several when multiple input/multiple output (MIMO) operation is in use). The eNB 12 is coupled via a data/control path 13 to the NCE 14. The path 13 may be implemented as the S1 interface shown in FIG. 1A. The eNB 12 may also be coupled to another eNB via data/control path 15, which may be implemented as the X2 interface shown in FIG. 1A.

For the purposes of describing the exemplary embodiments of this invention the UE 10 can be assumed to also include a SRS transmission unit (SRS TX Unit) 10E, and the eNB 12 includes a complementary SRS reception unit (SRS RX Unit) 12E. The UE 10 also includes various data buffers, including an UL data buffer (BUF) 10F.

At least one of the programs 10C and 12C is assumed to include program instructions that, when executed by the associated DP, enable the device to operate in accordance with the exemplary embodiments of this invention, as will be discussed below in greater detail. That is, the exemplary embodiments of this invention may be implemented at least in part by computer software executable by the DP 10A of the UE 10 and/or by the DP 12A of the eNB 12, or by hardware, or by a combination of software and hardware (and firmware). For example, the SRS TX Unit 10E can be implemented with a combination of computer software, as well as hardware embodied in baseband and radio frequency (RF) circuitry of the UE 10.

In general the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions. The UE 10 can in some embodiments be considered to embody what may be generically referred to as a “smartphone”.

The computer-readable memories 10B and 12B may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The data processors 10A and 12A may be of any type suitable to the local technical environment, and may include one or more of general purpose computers, special purpose computers, microprocessors, digital signal processors (DSPs) and processors based on multi-core processor architectures, as non-limiting examples.

The exemplary embodiments of this invention provide additional rules on top of any already discussed a-periodic SRS behavior, where the already discussed a-periodic SRS behavior may remain unchanged. In accordance with the exemplary embodiments the a-periodic SRS is only transmitted from the UE 10 if certain UE 10 conditions are fulfilled. Non-limiting examples of such UE 10 conditions can include, but are not limited to, (a) the UE 10 actually does have UL data for transmission (data stored in the UL buffer 10F), (b) the UE 10 has sent a scheduling request (SR, discussed at least in 3GPP TS 36.321, section 5.4.4), (c) the UE 10 has a SR transmission pending, (d) the UE 10 has triggered a SR transmission and/or (e) the UE 10 has a buffer status report (BSR) pending. The BSR reflects the status of at least the UL buffer 10F, and is discussed at least in 3GPP TS 36.321, section 5.4.5. Another possible UE 10 condition (f) is that the UE 10 has a semi-persistent allocation (e.g., see 3GPP TS 36.321, section 5.10.

Alternatively, the UE 10 should not transmit an a-periodic SRS if the UE 10 does not have UL data in its data buffer 10F for transmission (or pending re-transmissions), or if the UE 10 does not have a valid uplink timing alignment (TA).

In accordance with the exemplary embodiments of this invention, the UE 10 will transmit the a-periodic SRS as triggered, and as is illustrated in the upper part of FIG. 1B (noted here simply for referential purposes) if the UE 10 has UL data for transmission in its UL buffer 10F, or if the UE 10 has sent a SR (or based any other applicable rule, such as a rule from which it can be ascertained that the UE 10 has data for UL transmission).

Further in accordance with the exemplary embodiments the UE 10 will not transmit the triggered a-periodic SRS, as illustrated in the lower part of FIG. 1B, if the UE 10 does not have any UL data for transmission in its UL buffer 10F, or any re-transmission pending, or if the UE 10 does not have a valid UL TA.

Further in accordance with the exemplary embodiments, the a-periodic SRS transmission can be used as a substitute for a SR transmission, or it can be used in addition (or supplement) to the SR transmission (e.g., to enhance the UL SR reliability). That is, the SRS RX Unit 12E of the eNB 12 may interpret receipt of the SRS transmission as an indication that the UE 10 has data for transmission in its uplink data buffer 10F, and respond as if the UE 10 had transmitted a service or scheduling request. Alternatively, receipt of the a-periodic SRS can be used to validate a received SR from the UE 10.

It should also be noted that the decision to send or not send an a-periodic SRS can be based on a compound trigger condition, (e.g., IF (NOT (“outstanding transmitted scheduling request” OR “scheduling request pending”)) “don't send A-SRS” ELSE “send A-SRS”). Thus, it can be appreciated that the decision to send or not send an a-periodic SRS can be based on an occurrence of a single trigger condition, or it can be based on the occurrence of two or more trigger conditions (more generally, based on an occurrence of at least one trigger condition).

Based on the foregoing it should be apparent that the exemplary embodiments of this invention provide a method, apparatus and computer program(s) to enhance a-periodic SRS operation of the UE 10 and eNB 12.

The use of these exemplary embodiments provides a number of advantages and technical effects. For example, there is provided an intelligent usage of a-periodic SRS transmissions, improved UE 10 power consumption and a reduction in ‘blind’ or not technically useful a-periodic SRS transmissions. Further, the use of these exemplary embodiments can optimize operations of both the UE 10 and the eNB 12.

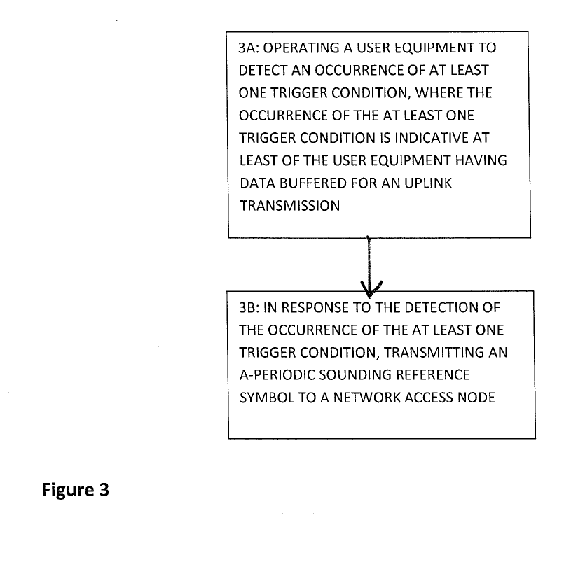

FIG. 3 is a logic flow diagram that illustrates the operation of a method, and a result of execution of computer program instructions, in accordance with the exemplary embodiments of this invention. In accordance with these exemplary embodiments a method performs, at Block 3A, a step of operating an apparatus such as one comprising a user equipment to detect an occurrence of at least one trigger condition, where the occurrence of the at least one trigger condition is indicative at least of the user equipment having data buffered for an uplink transmission. At Block 3B there is a step of, in response to the detection of the occurrence of the at least one trigger condition, transmitting an a-periodic sounding reference symbol to a network access node.

In accordance with the method shown in FIG. 3, where the at least one trigger condition indicates that the apparatus has transmitted a scheduling request to the network access node.

In accordance with the method shown in FIG. 3, where the at least one trigger condition indicates that the apparatus has a scheduling request transmission pending to the network access node.

In accordance with the method shown in FIG. 3, where the at least one trigger condition indicates that the apparatus has triggered a scheduling request transmission to the network access node (i.e. a scheduling request is triggered and considered pending).

In accordance with the method shown in FIG. 3, where the at least one trigger condition indicates that the apparatus has a buffer status report has been triggered or is pending for transmission to the network access node.

In accordance with the method shown in FIG. 3, where the at least one trigger condition indicates that the apparatus has a semi-persistent allocation.

In accordance with the method shown in FIG. 3, where the a-periodic sounding reference symbol is not transmitted to the network access node if the apparatus does not have any uplink data for transmission, or for re-transmission, or if the apparatus does not have a valid uplink timing alignment.

Further in accordance with the method shown in FIG. 3, where the at least one trigger condition is detected in response to a received command to transmit the sounding reference symbol, where the command is received from the network access node. In this embodiment, and in response to receipt of the command, detection of the at least one trigger condition can be achieved (e.g., detection of buffer or SR status).

Further in accordance with the method shown in FIG. 3, where the at least one trigger condition indicates that the apparatus has transmitted an empty or non-empty BSR to the network access node.

Further in accordance with the method shown in FIG. 3, where the at least one trigger condition comprises a compound trigger condition.

Also encompassed by the exemplary embodiments of this invention is a non-transitory computer-readable medium that contains software program instructions, where execution of the software program instructions by at least one data processor results in performance of operations that comprise execution of the method shown in FIG. 3 and described in the foregoing several paragraphs that refer to FIG. 3.

The various blocks shown in FIG. 3 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, the exemplary embodiments also pertain at least in part to an apparatus that comprises at least one processor and at least one memory including computer program code. The memory and computer program code are configured, with the at least one processor, to cause the apparatus at least to detect an occurrence of at least one trigger condition, where the occurrence of the at least one trigger condition is indicative at least of the apparatus having data buffered for an uplink transmission, and in response to the detection of the occurrence of the at least one trigger condition, to transmit an a-periodic sounding reference symbol to a network access node.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the UTRAN LTE-A) system, it should be appreciated that the exemplary embodiments of this invention are not limited for use with only this one particular type of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters (e.g., SRS, etc.) are not intended to be limiting in any respect, as these parameters may be identified by any suitable names. Further, the various names assigned to different channels (e.g., PUCCH, PUSCH, etc.) are not intended to be limiting in any respect, as these various channels may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
operating an apparatus to detect an occurrence of at least one trigger condition, where the occurrence of the at least one trigger condition is indicative at least of user equipment lacking a valid uplink timing alignment; and
receiving a command from a network access node to transmit an a-periodic sounding reference symbol; and
in response to the detection of the occurrence of the at least one trigger condition, ignoring the command to transmit the a-periodic sounding reference symbol to the network access node.

2. The method according to claim 1, further comprising:
In response to detection of a lack of occurrence of the at least one trigger condition, transmitting the a-periodic sounding reference symbol to the network access node in accordance with the command.

3. The method according to claim 1, where the at least one trigger condition further indicates that the apparatus has not transmitted a scheduling request to the network access node.

4. The method according to claim 1, where the at least one trigger condition further indicates that the apparatus does not have a scheduling request transmission pending to the network access node.

5. The method according to claim 1, where the at least one trigger condition further indicates that the apparatus does not have a buffer status report pending for transmission to the network access node.

6. The method according to claim 1, where the at least one trigger condition further indicates that the apparatus has transmitted an empty or non-empty buffer status report to the network access node

7. The method according to claim 1, where the at least one trigger condition further indicates that the apparatus does not have a semi-persistent allocation.

8. The method according to claim 1, where the at least one trigger condition is detected in response to receiving the command.

9. The method according to claim 1 where the apparatus is embodying a user equipment.

10. A non-transitory computer readable medium tangibly encoded with a computer program executable by a processor to perform actions comprising:
detecting an occurrence of at least one trigger condition, where the occurrence of the at least one trigger condition is indicative at least of user equipment lacking a valid uplink timing alignment; and
receiving a command from a network access node to transmit an a-periodic sounding reference symbol; and
in response to the detection of the occurrence of the at least one trigger condition, ignoring the command to transmit the a-periodic sounding reference symbol to the network access node.

11. The non-transitory computer readable medium according to claim 10 tangibly encoded with a computer program executable by a processor to perform actions further comprising:
in response to detection of a lack of occurrence of the at least one trigger condition, transmitting the a-periodic sounding reference symbol to the network access node in accordance with the command.

12. An apparatus comprising at least one processor; and at least one memory including computer program code; the at least one memory and the computer program code configured to, with the at least one processor, cause the apparatus at least to:
detect an occurrence of at least one trigger condition, where the occurrence of the at least one trigger condition is indicative at least of user equipment lacking a valid uplink timing alignment; and
receive command from a network access node to transmit an a-periodic sounding reference symbol; and
in response to the detection of the occurrence of the at least one trigger condition, ignore the command to transmit the a-periodic sounding reference symbol to the network access node.

13. The apparatus according to claim 12, the at least one memory and the computer program code configured to, with the at least one processor, further cause the apparatus at least to:
in response to detection of a lack of occurrence of the at least one trigger condition, transmit the a-periodic sounding reference symbol to the network access node in accordance with the command.

14. The apparatus according to claim 12, where the at least one trigger condition further indicates that the apparatus has not transmitted a scheduling request to the network access node.

15. The apparatus according to claim 12, where the at least one trigger condition further indicates that the apparatus does not have a scheduling request transmission pending to the network access node.

16. The apparatus according to claim 12, where the at least one trigger condition further indicates that the apparatus has not triggered a scheduling request transmission to the network access, where the triggered scheduling request is considered pending.

17. The apparatus according to claim 12, where the at least one trigger condition further indicates that the apparatus does not have a buffer status report that has been triggered or is pending for transmission to the network access node.

18. The apparatus according to claim 12, where the at least one trigger condition indicates that the apparatus has not transmitted an empty or non-empty buffer status report to the network access node.

19. The apparatus according to claim 12, where the at least one trigger condition further indicates that the apparatus does not have a semi-persistent allocation.

20. The apparatus according to claim 12, where detecting the at least one trigger condition is performed in response to receiving the command.
